(19) United States
(12) Patent Application Publication
(10) Pub. No.: US 2012/0229456 A1
(43) Pub. Date: Sep. 13, 2012

(54) THREE-DIMENSIONAL DISPLAY DEVICE

(75) Inventor: Hideyuki TAKAHASHI, Saitama-ken (JP)

(73) Assignee: Toshiba Mobile Display Co., Ltd., Fukaya-shi (JP)

(21) Appl. No.: 13/404,069

(22) Filed: Feb. 24, 2012

(30) Foreign Application Priority Data
Mar. 10, 2011 (JP) P2011-052751

(51) Int. Cl. G06T 15/00

(52) U.S. Cl. 345/419

(57) ABSTRACT

A three-dimensional display device includes a pair of substrates arranged opposing each other, a liquid crystal layer held between the pair of substrates, and a display region including a plurality of display pixels arranged in a matrix. A light control element is provided opposing the display region and is arranged periodically in a first direction. The light control element has substantially same characteristics in a second direction. The first direction crosses the second direction for giving a parallax in the first direction. Each pixel includes a plurality of sub-pixels arranged in the second direction, and a ratio of areas of respective sighted regions of the plurality of sub-pixels is constant in each display pixel.

### CROSS-REFERENCE TO RELATED APPLICATION

This application is based upon and claims the benefit of priority from Japanese Patent Application No. 2011-052751 filed Mar. 10, 2011, the entire contents of which are incorporated herein by reference.

### FIELD

Embodiments described herein relate generally to a three-dimensional display device.

### BACKGROUND

As display devices used in an electronic device, a liquid crystal display device and an organic electroluminescence display device have been developed. The liquid crystal display device is widely used for displays of electronic devices, such as a personal computer, an information personal digital assistant, a television set, and a car-navigation system taking advantage of its features, such as light weight, thin shape, and low power consumption.

Some displays capable of displaying not only a two-dimensional image but the three-dimensional image are proposed. In the display device capable of displaying the three-dimensional image, images for the right eye and for the left eye, for example, are individually prepared, and the display device is constituted so that the image for the right eye reaches the right eye, and the image for the left eye reaches the left eye using various means.

Various systems are proposed for the three-dimensional display device. In a parallax barrier system, a liquid crystal display panel for the barriers is arranged in the front of a display region of the liquid crystal display panel, and changes the pixels sighted by the right eye and the left eye using a shield portion and a transmissive portion of the liquid crystal display panel. In a system using a light controlling element, a visible image is switched with an angle at which a user sights the display region using the light controlling element installed in the front of the display region of the liquid crystal display panel. A lenticular lens is proposed as the light controlling element. When using the lenticular lens, the images which are visible in the right eye and the left eye are changed using the condensing characteristics of the lenticular lens.

In the three-dimensional display device using the slit or the lenticular lens, moire or color moire is easily caused by optical interference between a horizontal periodic structure of the light controlling element and the shield portion which respectively separates the display pixels arranged in the shape of a matrix in the plane display device or a horizontal periodic structure of the color arrangement of the display pixels.

As countermeasures against more, a method of tilting the periodicity of the light controlling element, namely, a method of tilting the lens is known. However, especially character display may be compromised because the straight lines extending vertically and horizontally may be displayed in a zigzag shape in the case of the three-dimensional image display according to this method.

In the lens in which there is no lens characteristic perpendicularly, and the periodicity of the lens is limited to a horizontal direction, compromise of the character display does not become a problem. However, in order to cancel color moire, it needs to adopt a color arrangement of the plane display, such as a mosaic arrangement and a horizontal stripe arrangement. Furthermore, a following method is proposed to cancel the moire due to the interference with a non-displaying portion which separates the respective pixels arranged in the shape of a matrix. In this method, a diffusion film is provided between the plane display device and the lenticular lens. Thereby, light from horizontally adjoining sub-pixels is synthesized, and the horizontal periodicity is eliminated. However, when the diffusion film is provided, the outside light may be scattered, and contrast may fall.

Conventionally, it is proposed to form an aperture shape of the display pixel so that a perpendicular aperture length may become constant to avoid the generation of the above-mentioned moire. Furthermore, another method is proposed to improve viewing angle characteristics. In this method, one display pixel is divided into a plurality of sub-pixels connected with an independent pixel switch to complement the respective images of the sub-pixels in order to improve the viewing angle characteristics. For example, when dividing one display pixel into two sub-pixels, the image formed by synthesizing the sub-pixel images is displayed on the display pixel. In this case, two sub-pixels are perpendicularly arranged in a line.

Moreover, when dividing one display pixel into two sub-pixels, for example, the sub-pixel arranged in an upper portion of the first display pixel arranged in a first row is synthesized with a sub-pixel arranged in an upper portion of a second display pixel arranged in a second row adjacent to the first display pixel in the perpendicular direction. Thereby, the display is formed so that the aperture length becomes constant for each display pixel.

Here, when using a lenticular lens with the same characteristic in a perpendicular direction as the light controlling element, for example, a region having minute width in the horizontal direction is sighted by being expanded on the perpendicular line.

The region expanded with the lenticular lens changes with positions of the viewpoint at this time. Accordingly, in the structure using a plurality of divided sub-pixels for one display pixel as mentioned above, there was a case where respective expanded sighted areas differ between the pixels depending on the viewpoints. In this case, since a gradation of the displayed image changes with the positions of the viewpoints, it was difficult to achieve pleasing display appearance.

### BRIEF DESCRIPTION OF THE DRAWINGS

The accompanying drawings, which are incorporated in and constitute a portion of the specification, illustrate embodiments of the invention, and together with the general description given above and the detailed description of the embodiments given below, serve to explain the principles of the invention.

FIG. 1 is a schematic illustration showing one example of the structure of a three-dimensional display device according to one embodiment.

FIG. 2A is a perspective view of one example of a light controlling element in the three-dimensional display device shown in FIG. 1.

FIG. 2B is a perspective view of another example of the light controlling element of the three-dimensional display device according to a first embodiment.

FIG. 3 is a plan view illustrating one example of a structure of a display region of the liquid crystal display panel of the three-dimensional display device shown in FIG. 1. FIG. 4 is an expanded plan view illustrating one example of a structure of the display pixel of the display portion shown in FIG. 3.

FIG. 5 is an expanded plan view illustrating one example of a structure of the display pixel in the three-dimensional display device according to a comparative example.

FIG. 6 is an expanded plan view illustrating an other example of a structure of the display pixel in the three-dimensional display device according to a comparative example.

FIG. 7 is a plan view illustrating an other example of a structure of the display region in the three-dimensional display device according to the first embodiment.

FIG. 8 is a plan view illustrating one example of a structure of the display region in the three-dimensional display device according to a second embodiment.

FIG. 9 is a a plan view illustrating another example of a structure of the display region in the three-dimensional display device according to the second embodiment.

FIG. 10 is an expanded plan view of an other example of a structure of the display region in the three-dimensional display device according to the first and second embodiments.

### DETAILED DESCRIPTION OF THE INVENTION

A three-dimensional display device according to an exemplary embodiment of the present invention will now be described with reference to the accompanying drawings wherein the same or like reference numerals designate the same or corresponding portions throughout the several views.

According to one embodiment, a three-dimensional display device, includes: a pair of substrates arranged opposing each other; a liquid crystal layer held between the pair of substrates; a display region including a plurality of display pixels arranged in a matrix; a light control element arranged opposing the display region, the light control element being arranged periodically in a first direction crossing a second direction and having a substantially same characteristics in the second direction for giving a parallax in the first direction; wherein each of the display pixels includes a plurality of sub-pixels arranged in the second direction and having respective aperture regions, wherein a ratio of sighted areas of the plurality of sub-pixels arranged in the second direction is constant in each display pixel.

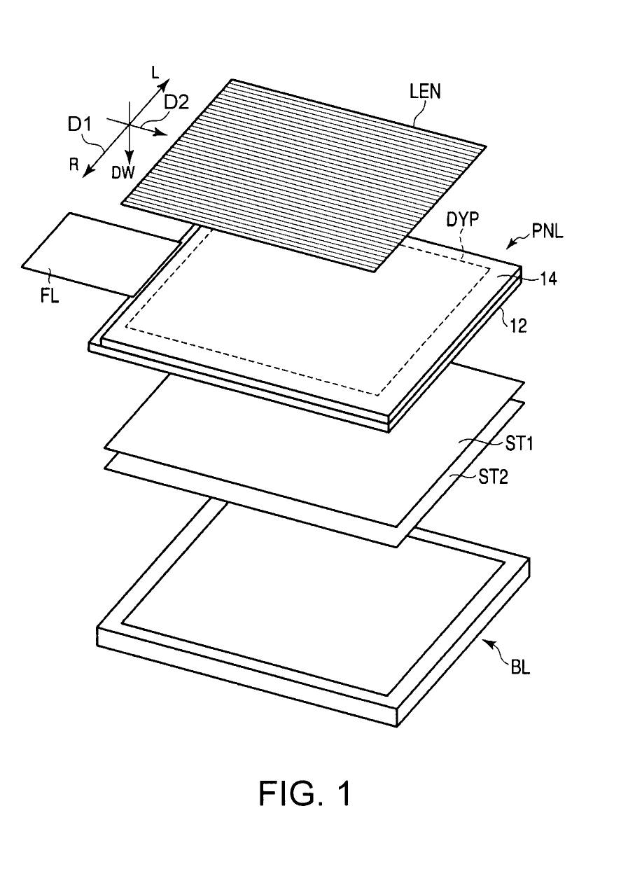

Hereafter, an embodiment is explained with reference to drawings. The example of a structure of the three-dimensional display device according to the first embodiment is shown in FIG. 1. The liquid crystal display device according to this embodiment includes a liquid crystal display panel PNL, a lighting device BL for radiating a display region DYP of the liquid crystal display panel PNL, a light control element LEN arranged on the display region DYP, a plurality of optical sheets ST1 and ST2 arranged between the liquid crystal display panel PNL and the lighting device BL. The optical sheets ST1 and ST2 are formed of a condensing sheet, a diffusion sheet, etc.

The liquid crystal display panel PNL includes an array substrate 12, a counter substrate 14 arranged opposing the array substrate 12, a liquid crystal layer LQ held between the array substrate 12 and the counter substrate 14, and a display region DYP including display pixels PX arranged in the shape of a matrix. A flexible substrate FL is electrically connected to one end of the array substrate 12 for transmitting images to outside, and receiving the signals from outside.

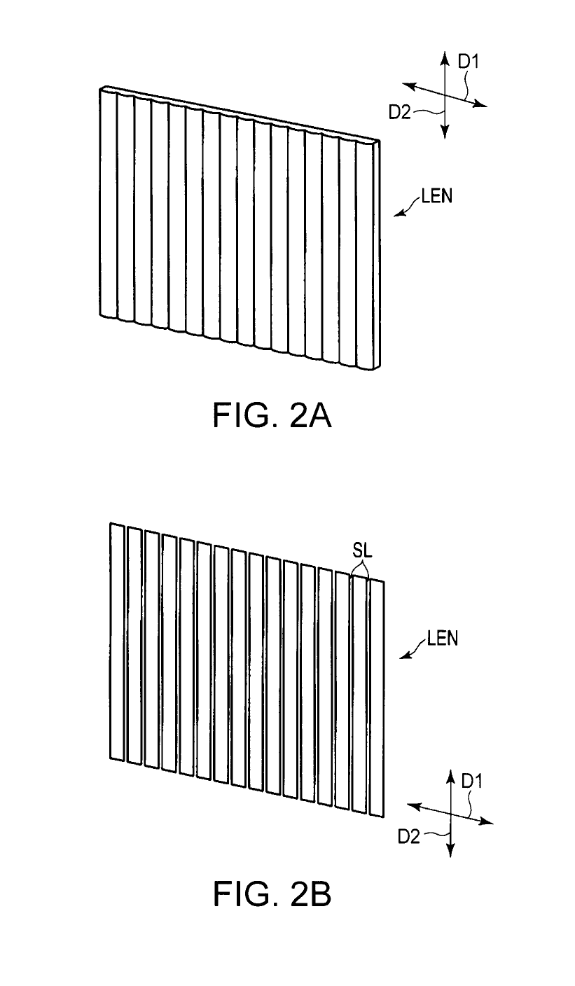

FIG. 2A is a perspective view of the lenticular sheet (cylindrical lens array) as the light controlling element LEN. In the lenticular sheet, a lens in which a cross-section in the first direction D1 becomes convex-like on the user side is arranged in a line in the first direction (horizontal direction) D1. The light emitted from the display region DYP is condensed with the lens of the lenticular sheet and is sighted by the user. Therefore, the user sights the image of a sighted area AR expanded with the lenticular sheet and extending in the second direction (perpendicular direction) D2.

FIG. 2B is a perspective diagram of a slit array as the light controlling element LEN. The slit array is equipped with a plurality of slits SL extending in the second direction D2. The slit SL of the slit array is periodically arranged in a line in the first direction D1. The light from the display region DYP is shielded in the region between the slits SL. The user sights the light emitted from the display region DYP which passes along slit SL of the slit array. That is, the user sights the image of the sighted area AR extending in the second direction D2 through the slits SL.

The light controlling element LEN changes the image in the first direction D1, which is visible with the position where the user sights the display region DYP. Therefore, even if the user sights one position in the light controlling element LEN, the user sights the image which changes with the user's positions. The light controlling elements LEN shown in FIG. 2A and FIG. 2B present right-and-left horizontal parallax difference, and the lenses or slits having the same characteristic in the second direction D2 are arranged in a line in the first direction D1.

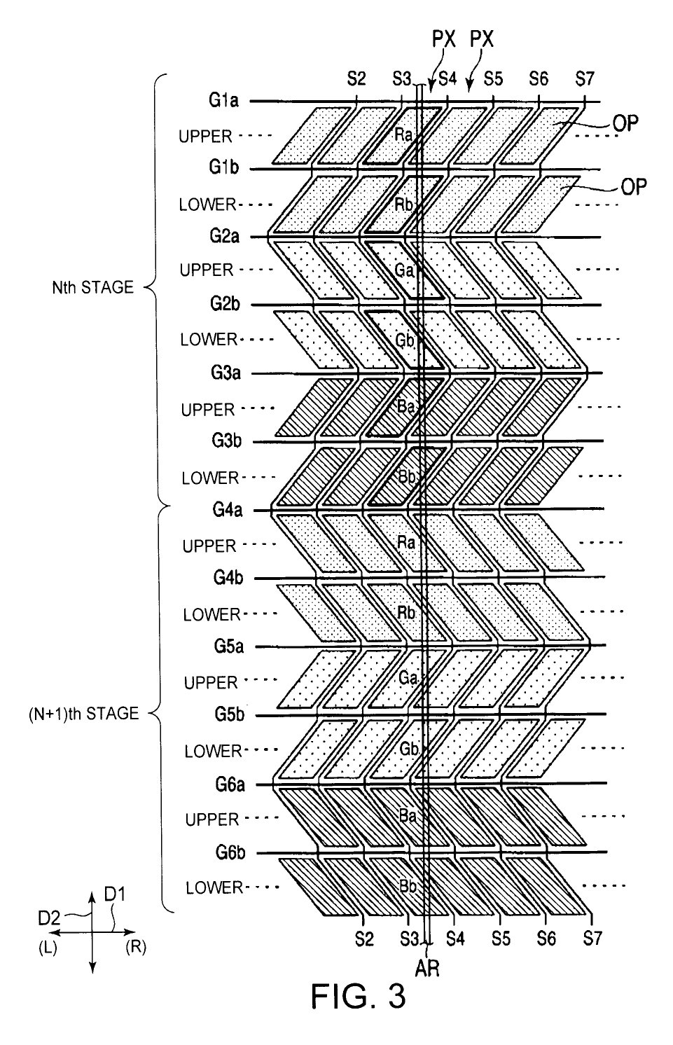

One example of a structure of the display region DYP is shown in FIG. 3. The three-dimensional display device according to this embodiment is a color type display device, and a plurality of display pixels PX have respectively three or more kinds of color display pixels, for example, a red pixel PXR, which displays red (R), a green pixel PXG which displays green (G), and a blue pixel PXB which displays blue (B). That is, the red pixel PXR is equipped with a red color filter (not shown) which passes the light of red dominant wavelength. The green pixel PXG is equipped with a green color filter (not shown) which passes the light of green dominant wavelength. The blue pixel PXB is equipped with a blue color filter (not shown) which passes the light of blue dominant wavelength. The color filter is arranged on the principal surface of the array substrate 12 or the counter substrate 14.

In the display region DYP, a plurality of stages of the display pixels constituted by a row line of the red pixels PXR, a row line of the green pixels PXG, and a row line of the blue pixel PXB are arranged along the second direction D2. FIG. 3 shows the color pixels PXR, PXG, and PXB arranged along with the Nth stage and the (N+1)th stage.

Each color pixel further includes a plurality of sub-pixels arranged in the second direction D2 along which the display pixels PX are arranged. In this embodiment, each of the color pixels PXR, PXG, and PXB includes two-sub pixels (Ra, Rb, Ga, Gb, Ba, Bb). In this example, one display pixel PX is constituted by six sub-pixels arranged in a line in the second direction D2, for example. The sub-pixels Ra, Rb, Ga, Gb, Ba, and Bb form one display pixel. Each sub-pixel is equipped with an aperture region OP of an approximate parallelogram shape. The aperture region OP is a region which the light emitted from the lighting device BL passes to the light controlling element side through the liquid crystal display panel PNL.

The array substrate 12 is equipped with a pixel electrode (not shown) arranged in each sub-pixel. The counter substrate 14 is equipped with a counter electrode (not shown) which counters the plurality of pixel electrodes. Corresponding image signals from an outside driving circuit or a driving circuit arranged around the display region DYP are impressed to the pixel electrodes. A counter voltage is impressed to the counter electrode from the outside driving circuit or the driving circuit where the counter electrode is arranged around the display region DYP. The transmissivity of the light in the aperture region OP is controlled by controlling the state for alignment of the liquid crystal molecule contained in a liquid crystal layer by potential difference between the image signal impressed to the pixel electrode in each sub-pixel and the counter voltage.

FIG. 4. shows one example of a structure of the display pixel PX arranged at the Nth stage. Around the aperture region OP, a shield portion is arranged in the shape of a lattice on the array substrate 12 or the counter substrate 14 (which is not illustrated). The aperture region OP is surrounded by a pair of ends E1 extending in the first direction D1, and a pair of ends E2 extending between the ends E1 in parallel. The shield portion is formed with a black colored resin, for example.

In the case shown in FIG. 4, the end E2 is slanted to the right side (R) from the second direction D2 in the aperture regions OP of the sub-pixels Ra and Rb of the red pixel PXR. The respective forms of the aperture regions OP of the sub-pixels Ra and Rb are the same. The aperture regions OP of the sub-pixels Ra and Rb are arranged along with the second direction D2. Namely, four corresponding angle portions of the sub-pixels Ra and Rb are arranged along with a line parallel to the second direction D2. Accordingly, the ratio of the sighted areas AR of the sub-pixel Ra and the sub-pixel Rb is constant in the second direction D2. In this embodiment, the sighted area AR of the sub-pixel Ra is same as that of the sub-pixel Rb.

In the aperture regions OP of the sub-pixels Ga and Gb of the green pixel PXG, the end E2 slants to the left side (L) from the second direction D2. The respective forms of the aperture regions OP of the sub-pixels Ga and Gb are the same, and have line symmetry with the aperture regions OP the sub-pixels Ra and Rb with respect to a parallel line to the first direction D1. The respective aperture regions OP of the sub-pixels Ga and Gb are slanted in the second direction D2. Namely, corresponding four angle portions of the sub-pixels Ga and Gb are arranged along with a line parallel to the second direction D2. Accordingly, the ratio of the sighted areas AR of the sub-pixel Ga and the sub-pixel Gb is constant in the second direction D2. In this embodiment, the sighted area AR of the sub-pixel Ga is same as that of the sub-pixel Gb.

In the aperture regions OP of the sub-pixels Ba and Bb of the blue pixel PXB, the end E2 slants to the right (R) side from the second direction D2. The respective forms of the aperture regions OP of the sub-pixels Ba and Bb are the same. The respective aperture regions OP of the sub-pixels Ga and Gb are arranged in the second direction D2. Further, the sub-pixels Ba and the sub-pixels Bb have line symmetry with the aperture regions OP the sub-pixels Ga and Gb with respect to a line parallel to the first direction D1. Namely, four respective corresponding angle portions of the sub-pixels Ba and Bb are arranged along with a line parallel to the second direction D2. Accordingly, the ratio of the sighted areas AR of the sub-pixel Ba and the sub-pixel Bb is constant in the second direction D2. In this embodiment, the sighted area AR of the sub-pixel Ba is same as that of the sub-pixel Bb.

The forms of the aperture regions OP of the sub-pixels Ra, Rb, Ga Gb, Ba and Bb arranged at the (N+1)th stage and the Nth stage have line symmetry with respect to a line parallel to the second direction D2. That is, wherein FIG. 4 shows the Nth stage at the (N+1)th stage shown in FIG. 3, the ends E2 of the aperture regions OP of the sub-pixel Ra and Rb respectively slant to the left side (L) from the second direction D2. The respective forms of the aperture regions OP of the sub-pixels Ra and Rb are the same. Namely, four corresponding angle portions of the sub-pixels Ra and Rb are arranged along with a line parallel to the second direction D2. Accordingly, the ratio of the sighted areas AR of the sub-pixel Ra and the sub-pixel Rb is constant in the second direction D2. In this embodiment, the sighted area AR of the sub-pixel Ra is same as that of the sub-pixel Rb.

The ends E2 of the aperture regions OP of the sub pixels Ga and Gb of the (N+1)th stage slant to the right side (R) from the second direction D2. The respective forms of the aperture regions OP of the sub-pixels Ga and Gb are same. The aperture regions OP of the sub-pixels Ga and Gb and the aperture regions OP of the sub-pixels Ra and Rb have line symmetry with respect line to a line parallel to the first direction. Namely, four corresponding angle portions of the sub-pixels Ga and Gb are arranged along with a parallel line to the second direction D2. Accordingly, the ratio of the sighted areas AR of the sub-pixel Ga and the sub-pixel Gb is constant in the second direction D2. In this embodiment, the sighted area AR of the sub-pixel Ga is the same as that of the sub-pixel Gb.

The ends E2 of the aperture regions OP of the sub pixels Ba and Bb of the (N+1)th stage slant to the left side (L) from the second direction D2. The respective forms of the aperture regions OP of the sub-pixels Ba and Bb are same. The aperture regions OP of the sub-pixels Ba and Bb and the aperture regions OP of the sub-pixels Ga and Gb have line symmetry with respect line to a line parallel to the first direction. Namely, four respective corresponding angle portions of the sub-pixels Ba and Bb are arranged along with a parallel line to the second direction D2. Accordingly, the ratio of the sighted areas AR of the sub-pixel Ba and the sub-pixel Bb is constant in the second direction D2. In this embodiment, the sighted area AR of the sub-pixel Ba is same as that of the sub-pixel Bb.

In the display region DYP, as shown in FIG. 3 a plurality of scanning lines G (Gna, Gnb; n=1, 2 and 3, . . . ) are arranged along with the row line in which the sub-pixels of the display pixels PX are arranged. Furthermore, the signal lines S (Sn; n=1, 2 and 3, . . . ) are arranged in the column direction (the second direction D2) so that the signal lines S may weave between the aperture regions OP of the sub-pixels of the display pixel PX.

In the circumference of the aperture region OP, the scanning line G and the signal line S are arranged so that the respective lines counter with a shield portion (not shown). For example, in the circumference of the sub-pixels Ra and Rb of the red pixel PXR, the signal line S4 is arranged along the end E2 extending in the direction slanting to the right side (R) from the second direction D2. The signal line S4 turns between the red pixel PXR and the green pixel PXG. In the circumference of the sub pixels Ga and Gb of the green pixel PXG, the signal line S4 is arranged along the end E2 extending in the direction slanting to the left side (L) from the second direction D2. Further, the signal line 4 turns between the green pixel PXG and the blue pixel PXB. In the circumference of the sub pixel Ba and Bb of the blue pixel PXB, the signal line S4 is arranged along the end E2 extending in the direction slanting to the right side (R) from the second direction D2.

A pixel switch (not shown) is arranged near the crossing position of the scanning line G and the signal line S at the shield portion. The pixel switch is formed of a thin film transistor. The gate line is electrically connected with the corresponding scanning line G (or integrally formed), and the source electrode is connected with the corresponding signal lines (or integrally formed). Further, the drain electrode is electrically connected with the corresponding pixel electrode (or integrally formed).

In the various color pixels, the pixel electrodes of the sub-pixels Ra, Ga, and Ba arranged on the upper side are connected with the drain electrode of the pixel switch, or integrally formed. The gate electrode of the pixel switch is connected to the scanning line Gna, or is integrally formed with the scanning line Gna. Similarly, the pixel electrodes of the sub-pixels Ra, Ga, and Ba arranged on the lower side are connected with the drain electrode of the pixel switch, or integrally formed. The gate electrode of the pixel switch is connected to the scanning line Gnb, or is integrally formed with the scanning line Gnb.

In this embodiment, the pixel electrode arranged in each sub-pixel is connected with the signal line S arranged on the left (L) side through the pixel switch. That is, an image signal is supplied to the pixel electrodes arranged on the sub-pixels Ra, Gb, and Ba from the signal line S3 through the pixel switch. The image signal is supplied to the pixel electrodes arranged in the sub pixels Rb, Ga, and Bb from the signal line S4 through the pixel switch.

Thus, when each of the color pixels PXR, PXG, and PXB is divided into two sub-pixels driven independently, the red pixel PXR displays the synthesized images by the sub-pixels Ra and Rb. The green pixel PXG displays the synthesized image by the sub-pixels Ga and Gb. Similarly, the blue pixel PXG displays the synthesized image by the sub-pixel Ba and Bb.

Furthermore, the sub-pixel Ra of the red pixel PXR arranged at the Nth stage is synthesized with the sub-pixel Ra of the red pixel PXR arranged at the (N+1)th stage, and the area of the sighted region AR in the vertical direction becomes constant. Namely, when a pixel PX is arranged in the display region DYP, the area of the sighted region AR by the user through the light controlling element LEN becomes as follows. The areas of the synthesized sighted regions by the sub-pixel Ra arranged at the Nth stage and the sub pixel Ra of the red pixel PXR arranged at the (N+1)th become constant. Moreover, the areas of the synthesized sighted regions of the sub pixel Rb arranged at the Nth stage and the sub-pixel Rb of the red pixel PXR arranged at the (N+1)th also become constant.

The areas of synthesized sighted regions AR by the sub-pixel arranged on the upper side at the Nth stage and the sub-pixel arranged on the upper side at the (N+1)th stage also become constant about the green pixel PXG and the blue pixel PXB. Similarly, the areas of synthesized sighted regions AR by the sub-pixel arranged on the lower side at the Nth stage and the sub-pixel arranged on the lower side at the (N+1)th stage become constant about the green pixel PXG and the blue pixel PXB.

In the three-dimensional display device according to this embodiment, the areas of the synthesized sighted regions by the sub-pixels arranged on the upper side at the Nth stage and the sub-pixel arranged on the upper side at the (N+1) stage become constant for various color pixels as mentioned-above. Similarly, the synthesized sighted region by the sub-pixel arranged on the lower side at the Nth stage and the sub-pixel arranged at the (N+1)th stage on the lower side becomes constant. Accordingly, the moire produced due to interference of light is cancelable.

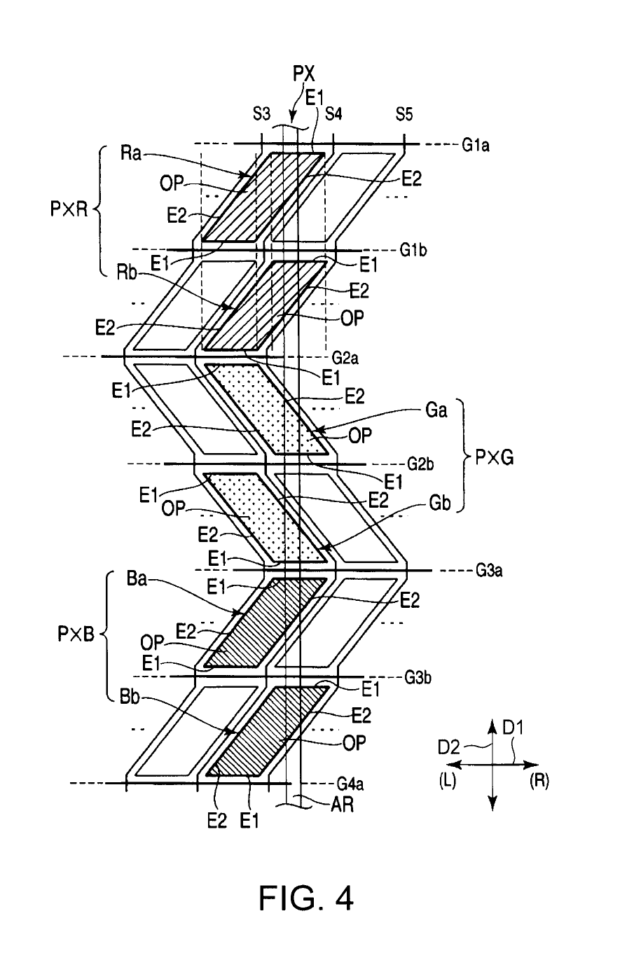

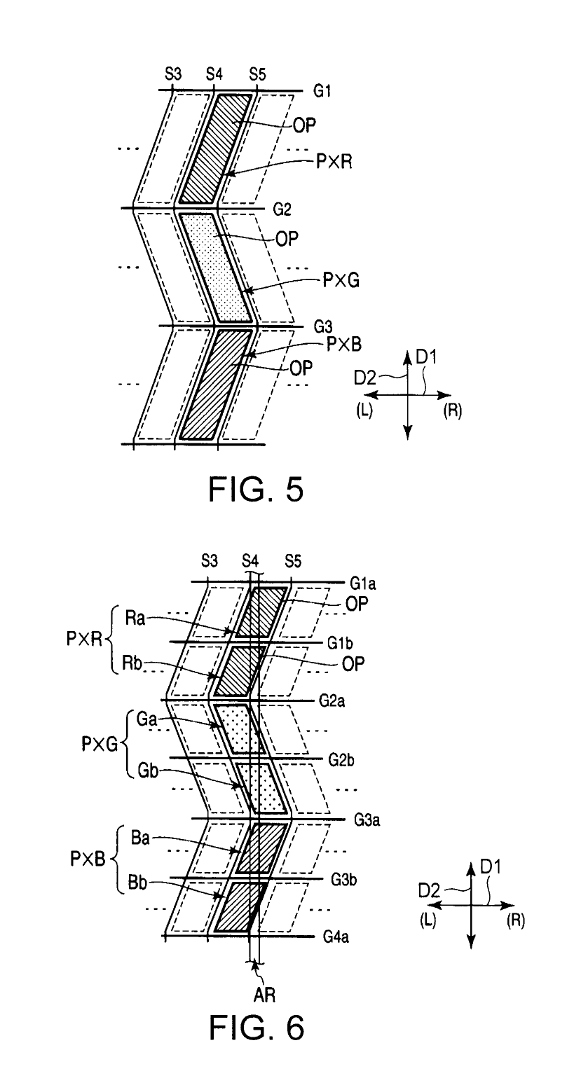

On the other hand, as shown in FIG. 5, for example, when each color pixel is not divided into sub-pixels, the areas of the synthesized regions where the color pixels at the N stage and the (N+1)th stage of the color pixels are sighted become constant. If the color pixel arranged in this way is reviewed about the case where the pixel is divided into two sub-pixels as shown in FIG. 6, the areas of the synthesized regions where the sub-pixels arranged on the upper side at the Nth stage and the sub-pixels arranged on the upper side at the (N+1)th stage are sighted become constant. Similarly, the synthesized region where the sub-pixels arranged on the lower side at the Nth stage and the sub-pixels arranged on the lower side at the (N+1)th stage are sighted become constant for various color pixels.

However, in this case, the ratio of the areas of the synthesized sighted regions AR of the two sub-pixels change with the angles at which the user sights the display region DYP in this case. The two sub-pixels can complement one image by displaying different gradation images. Therefore, if the area of the sighted regions RA in the sub-pixels change depending on the angles at which the user sights the display region DYP, the gradation may change depending on the angles at which the user sights the display regions DYP. This results in decrease in the display quality of the display region GYP.

On the other hand, in the three-dimensional display device according to this embodiment, the ratio of the areas of sighted regions AR of the two sub-pixels in each color pixel becomes constant for the various pixels. In this embodiment, the ratio of the areas of sighted regions AR of two sub-pixels of each color pixel becomes 1:1 regardless of the angles at which the user sights the display region DYP. Therefore, the gradation of the image sighted with the angle at which the user sights the display region DYP does not change, and good display grace can be realized.

That is, in the three-dimensional display device according to this embodiment, it becomes possible to offer a high quality three-dimensional display device in which the morie is eliminated and the viewing angle characteristic is improved.

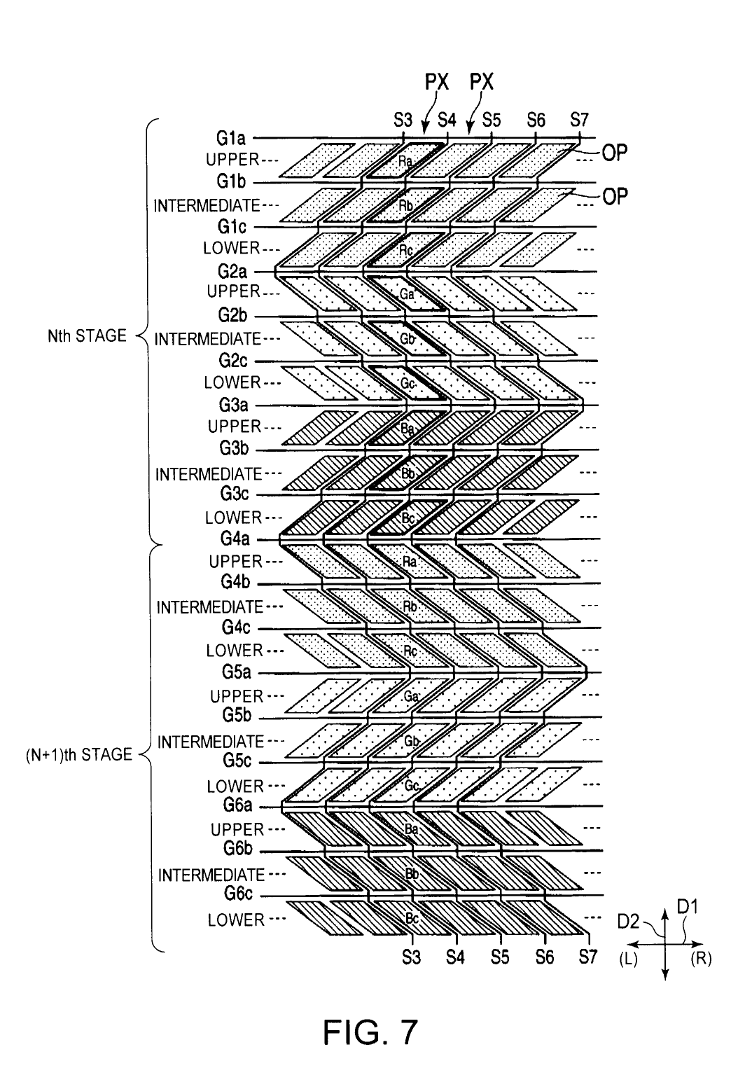

Other example of a structure of the display region DYP of the three-dimensional display device according to the first embodiment is shown in FIG. 7. In this example, each of the color pixels PXR, PXG, and PXB is divided into three sub-pixels. For example, the red pixel PXR is divided into the sub-pixels Ra, Rb, and Rc. Each of the sub-pixels Ra, Rb, and Rc include an aperture region OP of an approximate parallelogram.

FIG. 7 shows the display pixel PX arranged at the Nth stage and the (N+1)th stage. In the display pixel PX arranged at the Nth stage, the aperture regions OP of the sub-pixels Ra, Rb, and Rc of the red pixel PXR, the ends E2 slant to the right side (R) from the second direction D2. The forms of the aperture regions OP of the sub-pixels Ra, Rb, and Rc are respectively same. The aperture regions OP of the sub-pixels Ra, Rb, and Rc are arranged along with the second direction D2. Namely, corresponding four angle portions of the aperture regions OP of the sub-pixels Ra, Rb, and Rc are arranged along a parallel line to the second direction D2.

In the aperture regions OP of the sub-pixels Ga, Gb, and Gc of the green pixel PXG, the ends E2 slant to the left side (L) from the second direction D2. The forms of the aperture regions OP of the sub-pixels Ga, Gb, and Gc are respectively same, and are line symmetry with the sub-pixels Ra, Rb, and Rc with respect to a parallel line to the first direction D1. Namely, corresponding four angle portions of the aperture regions OP of the sub-pixels Ga, Gb, and Gc are arranged along a parallel line to the second direction D2.

In the aperture regions OP of the sub-pixels Ba, Bb, and Bc of the blue pixel PXB, the ends E2 slant to the left side (R) from the second direction D2. The forms of the aperture regions OP of the sub-pixels Ba, Bb, and Bc are respectively same, and are line symmetry with the sub-pixels Ga, Gb, and Gc with respect to a parallel line to the first direction D1. Namely, corresponding four angle portions of the aperture regions OP of the sub-pixels Ba, Bb, and Bc are arranged along a parallel line to the second direction D2.

The shape of the aperture regions OP of the sub-pixels Ra, Rb, Rc, Ga Gb, Gc, Ba, Bb, and Bc of the pixels arranged at the (N+1)th stage have line symmetry with the corresponding forms of the aperture regions of the pixels arranged in the Nth stage with respect to a parallel line to the first direction D1. That is, in the pixel arranged at the (N+1)th stage, the ends E2 of the aperture regions OP of the sub-pixel Ra, Rb, and Rc slant to the left side (L) from the second direction D2. The respective forms of the aperture regions OP of the sub-pixels Ra, Rb, Rc are the same. Namely, corresponding four angle portions of the aperture regions OP of the sub-pixels Ra, Rb, and Rc are arranged in a parallel line to the second direction D2.

In the aperture regions OP of the sub-pixels Ga, Gb, and Gc of the green pixel PXG, the ends E2 slant to the right side (R) from the second direction D2. The respective forms of the aperture regions OP of the sub-pixels Ga, Gb, and Gc are the same. The forms of the aperture regions OP of the sub-pixels Ga, Gb, and Gc have line symmetry with the forms of the aperture regions OP of the sub-pixels Ra, Rb, and Rc with respect to a parallel line to the first direction D1. Namely, corresponding four angle portions of the aperture regions OP of the sub-pixels Ga, Gb, and Gc are arranged along a parallel line to the second direction D2.

In the aperture regions OP of the sub-pixels Ba, Bb, and Bc, the ends E2 slant to the left side (L) from the second direction D2. The respective forms of the aperture regions OP of the sub-pixels Ba, Bb, and Bc are the same. The forms of the aperture regions OP of the sub-pixels Ba, Bb, and Bc have line symmetry with the forms of the sub-pixels Ra, Rb, and Rc with respect to a parallel line to the first direction D1. Namely, corresponding four angle portions of the aperture regions OP of the sub-pixels Ba, Bb, and Bc are arranged along a parallel line to the second direction D2.

As mentioned-above, the structure of this embodiment is the same as that of the three-dimensional display device according to the above-mentioned first embodiment except for each color pixel being divided into three sub-pixels.

In the example shown in FIG. 7, the area of sighted region becomes constant by synthesizing the sub-pixel arranged in the upper side at the Nth stage with the sub-pixel arranged on the upper side arranged at the (N+1)th stage in the various color pixels. The sub-pixel arranged in the middle at the Nth stage is synthesized with the sub-pixel arranged in the middle at the (N+1)th stage, and the synthesized sighted area AR becomes constant. In this embodiment, the synthesized sighted area AR becomes the same. Similarly, by synthesizing the sub-pixel arranged on the lower side at the Nth stage with the sub-pixel arranged on the lower side at the (N+1)th stage, the sighted area AR becomes constant. In this embodiment, the synthesized sighted area AR becomes the same.

In this example, the area ratio of the regions where three sub-pixels of each color pixel are sighted is constant, for example, the same. In the case shown in FIG. 7, since the form of the aperture regions OP of the three sub-pixels is the same, the area ratio of the sighted regions becomes constant regardless of the angle at which the user sights the display region DYP. Therefore, the gradation of the image sighted with the angle at which the user sights the display region DYP does not change, and high quality display can be realized.

That is, even in the case where the display region DYP for displaying the three-dimensional image is constituted as shown in FIG. 7, while canceling moire, it becomes possible to offer a high quality three-dimensional display device in which the viewing angle characteristic can be improved.

Next, the three-dimensional display device according to a second embodiment is explained with reference to drawings. In addition, in the following explanation, the same designation is given to the same or corresponding element as in the three-dimensional display device according to the above-mentioned first embodiment, and its explanation is omitted.

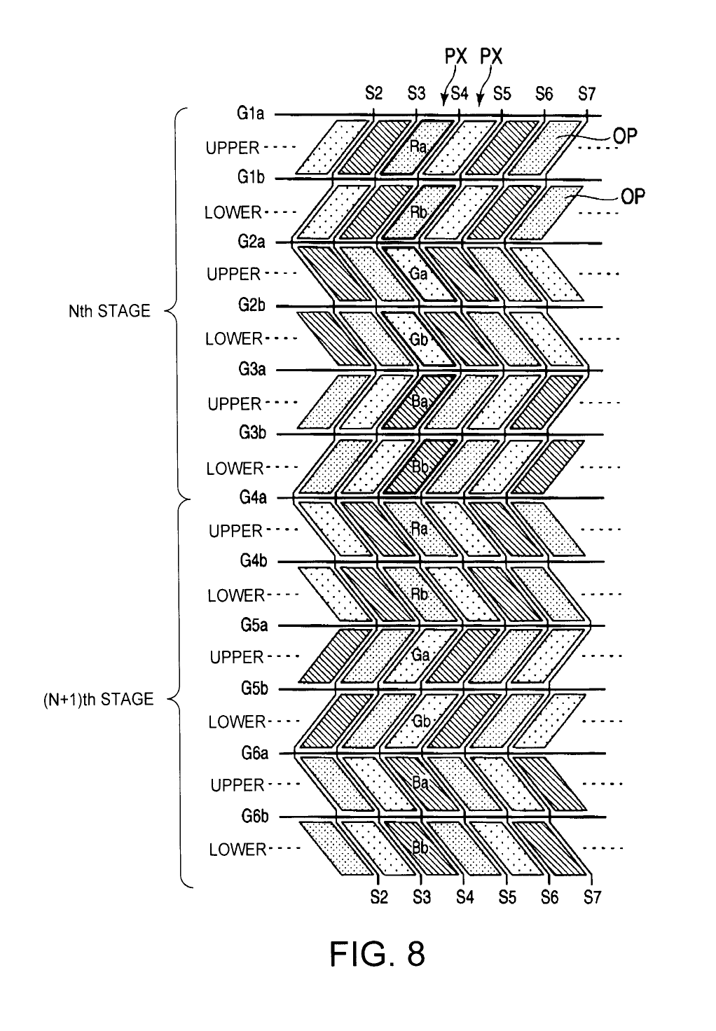

One example of the composition of the display region DYP of the three-dimensional display device according to this embodiment is schematically shown in FIG. 8. The three-dimensional display device according to this embodiment is a color type display device, and a plurality of display pixels PX have a plurality of color pixels, for example, the red pixel PXR which displays red (R), the green pixel PXG which displays green (G), and the blue pixel PXB which displays blue (B).

In this embodiment, the red pixel PXR, the green pixel PXG, and the blue pixel PXB are arranged in the shape of a mosaic. That is, in the first direction D1 and the second direction D2, the red pixel PXR, the green pixel PXG, and the blue pixel PXB are arranged so that the color pixels of different colors adjoin. In FIG. 8, in the first direction D1, the pixels are arranged side by side from the left (L) side to the right (R) side in order of the red pixel PXR, the green pixel PXG, and the blue pixel PXB. Further, the pixels are arranged side by side from the upper portion to the lower portion in order of the red pixel PXR, the green pixel PXG, and the blue pixel PXB.

The red pixel PXR, the green pixel PXG, and the blue pixel PXB include a plurality of sub-pixels, respectively. The arrangement position of the sub-pixels is the same as that of the three-dimensional display device according to the above-mentioned first embodiment. When the red pixel PXR, the green pixel PXG, and the blue pixel PXB include two sub-pixels, respectively, each sub-pixel is arranged as shown in FIG. 4. The form of the aperture regions OP of two sub-pixels of each color pixel is an approximate parallelogram, and the corresponding corner portions of the two aperture regions OP are arranged on a parallel line to the second direction D2.

That is, the area ratio of the sighted regions AR of the two sub-pixels of each color pixel becomes constant. Since the form of the aperture regions OP of the two sub-pixels of each color pixel is the same, the area ratio of the sighted regions AR with the angle at which the user sights the display region DYP becomes 1:1. Therefore, the gradation of the sighted image does not change regardless of the angle at which the user sights the display region DYP, and high quality display can be realized.

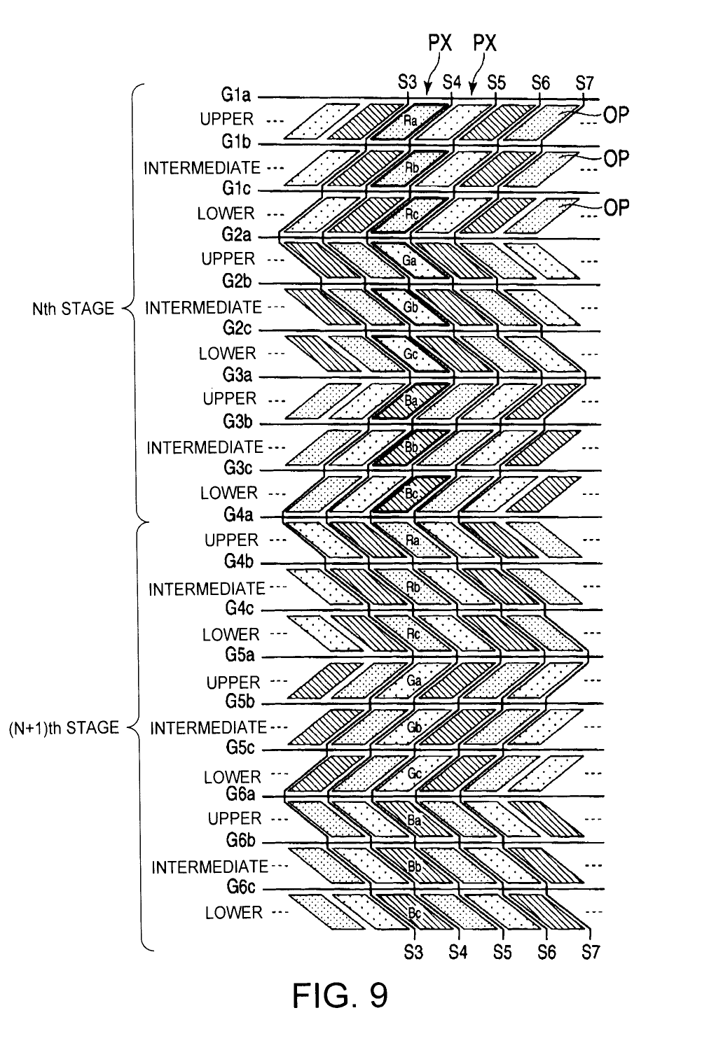

Another example of the structure of the display region DYP of the three-dimensional display device according to the first embodiment is shown in FIG. 9. In this example, each of the color pixels PXR, PXG, and PXB includes three sub-pixels. The form of the aperture regions OP of the three-sub-pixels of each color pixel is an approximate parallelogram, and the corner portions of the three aperture regions OP are arranged on a parallel line to the second direction D2.

In this example, the area ratio of the regions at which the three sub-pixels of each color pixel are sighted is constant. For example, in the case shown in FIG. 7, since the form of the aperture regions OP of the three sub-pixels is same, the area ratio of the sighted regions at which the user sights the three sub-pixels becomes 1:1:1 regardless of the angle at which the user sights the display region DYP. Therefore, the gradation of the sighted image with the angle at which the user sights the display region DYP does not change, and high quality display device can be realized.

That is, in case display region DYP is constituted as shown in FIG. 9, it becomes possible to offer a high quality three-dimensional display device in which morie is eliminated and the viewing angle characteristic is improved.

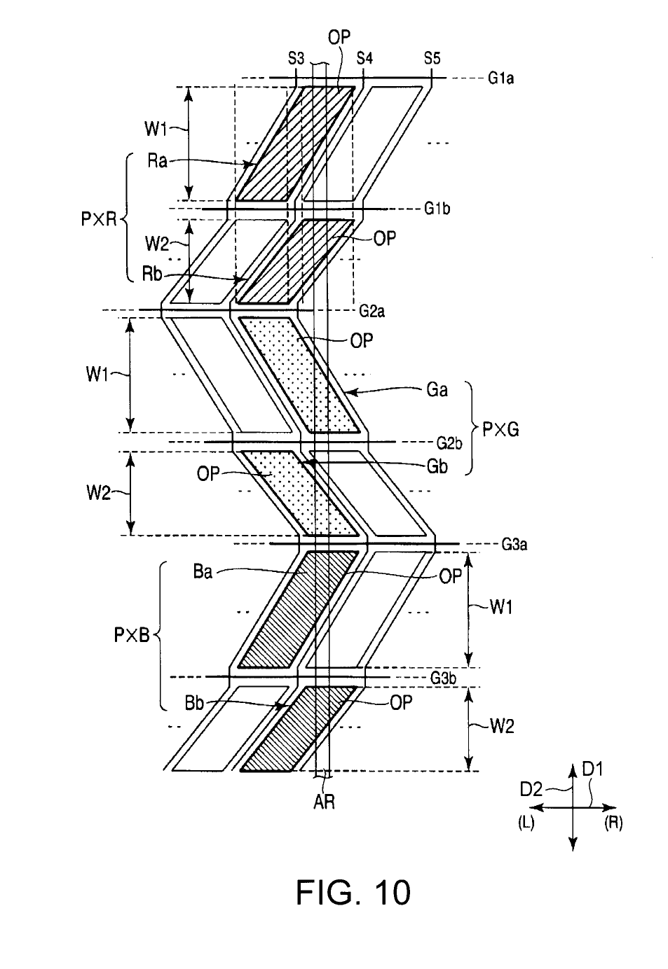

FIG. 10 shows a modification of the three-dimensional display device according to the above-mentioned first and second embodiments. Here, the width of the sub-pixel arranged in each color pixel on the upper side, and the respective sub-pixel arranged on the lower side in the second direction D2 is different. Even if the width in the parallel direction with the second direction D2 changes, the respective ratio of each region where two sub-pixels of each color pixel are sighted becomes constant. For example, in the case shown in FIG. 10, since the form of the aperture regions OP of two sub-pixels is same, the area ratio of the sighted region with the angle at which the user sights the display region DYP becomes W1:W2. Therefore, the gradation of the image sighted with the angle at which the user sights the display region DYP does not change, and high quality display can be realized.

That is, in case the display region DYP is constituted as shown in FIG. 10, it becomes possible to offer a high quality three-dimensional display device in which morie is eliminated and the viewing angle characteristic is improved.

Moreover, in the above-mentioned first and second embodiments, the pixel switch formed in each sub-pixel is arranged so that the electrical path between the signal line S arranged on the left side (L) and the pixel electrode is switched. However, the pixel switches of the two sub-pixels may be arranged so that two-pixel switches may switch an electrical path between the common signal line S and the respective pixel electrodes. For example, in the case shown in FIG. 4, the pixel electrode arranged at the sub-pixels Ra, Rb, Ga, Gb, Ba, and Bb may be electrically connected with the signal line S4 through the pixel switch. Thus, even if the pixel switches are arranged as described-above, the same effect as the above-mentioned first and second embodiments can be acquired.

While certain embodiments have been described, these embodiments have been presented by way of embodiment only, and are not intended to limit the scope of the inventions. In practice, the structural elements can be modified without departing from the spirit of the invention. Various embodiments can be made by properly combining the structural elements disclosed in the embodiments. For embodiment, some structural elements may be omitted from all the structural elements disclosed in the embodiments. Furthermore, the structural elements in different embodiments may properly be combined. The accompanying claims and their equivalents are intended to cover such forms or modifications as would fall with the scope and spirit of the inventions.

What is claimed is:

1. A three-dimensional display device, comprising:
a pair of substrates arranged opposing each other;
a liquid crystal layer held between the pair of substrates;
a display region including a plurality of display pixels arranged in a matrix;
a light control element opposing the display region and arranged periodically in a first direction, the light control element having substantially same characteristics in a second direction, the first direction crossing the second direction for giving a parallax in the first direction; wherein
each of the display pixel includes a plurality of sub-pixels arranged in the second direction and having respective aperture regions, and
a ratio of sighted areas of the plurality of sub-pixels arranged in the second direction is constant in each display pixel.

2. The three-dimensional display device according to claim 1, wherein the sighted areas of the plurality of sub-pixels arranged in the second direction are substantially the same in each display pixel.

3. The three-dimensional display device according to claim 1, wherein the form of each aperture region is approximately a parallelogram, and corresponding four corner portions of the plurality of sub-pixels are arranged on a line approximately parallel with the second direction.

4. The three-dimensional display device according to claim 1, wherein the forms of the aperture regions of the plurality of sub-pixels of each display pixel are substantially the same.

5. The three-dimensional display device according to claim 1, wherein the light control element comprises a lentcuilar sheet.

6. The three-dimensional display device according to claim 1, wherein the light control element comprises slits.

7. A three-dimensional display device, comprising:
a pair of substrates arranged opposing each other;
a liquid crystal layer held between the pair of substrates;
a display region including a plurality of color pixels of different color each arranged in a stripe shape in a first direction;
a light control element having substantially same characteristics in a second direction crossing the first direction and arranged opposing the display region, the light control element being arranged periodically in the first direction for giving a parallax in the first direction; wherein
each of the color pixel includes a first sub-pixel and a second sub-pixel respectively having an aperture region and arranged in the second direction,
an area ratio of sighted regions in a first sub-pixel and a second sub-pixel arranged in the second direction is constant in each color pixel, and
the form of the aperture region is approximately that of a parallelogram, and respective four corner portions of the first and second sub-pixels of each color pixel are arranged on a line approximately parallel to the second direction.

8. The three-dimensional display device according to claim 7, wherein the sighted areas of the first and second sub-pixels of each color pixel are substantially the same.

9. The three-dimensional display device according to claim 7, wherein the color pixels comprises a red color pixel, a green color pixel, and a blue color pixel.

10. The three-dimensional display device according to claim 7, wherein the light control element comprises a lentcuilar sheet.

11. The three-dimensional display device according to claim 7, wherein the light control element comprises slits.

12. A three-dimensional display device, comprising:
a pair of substrates arranged opposing each other;
a liquid crystal layer held between the pair of substrates;
a display region including a plurality of color pixels respectively comprising a plurality of sub-pixels each having an aperture region;
a light control element opposing the display region and arranged periodically in a first direction and having substantially same characteristics in a second direction, the first direction crossing the second direction for giving a parallax in the first direction; wherein
the plurality of color pixels are periodically arranged so that different color pixels are arranged adjacent each other in the first and second directions,
an area ratio of the sighted regions in the plurality of sub-pixels of each color pixel is constant, and
the shape of the aperture region is approximately that of a parallelogram, and respective four corner portions of the plurality of sub-pixels of each color pixel are arranged on a line approximately parallel to the second direction.

13. The three-dimensional display device according to claim 12, wherein the sighted areas of the plurality of sub-pixels are substantially the same in each color pixel.

14. The three-dimensional display device according to claim 12, wherein the forms of the aperture regions of the plurality of sub-pixels of each color pixel are substantially the same.

15. The three-dimensional display device according to claim 12, wherein the light control element comprises a lentcuilar sheet.

16. The three-dimensional display device according to claim 12, wherein the light control element comprises slits.

17. A three-dimensional display device, comprising:
a pair of substrates arranged opposing each other;
a liquid crystal layer held between the pair of substrates;
a display region including a plurality of color pixels of red, green , and blue color arranged in that order along a first direction;
a light control element having substantially same characteristics in a second direction crossing the first direction and arranged opposing the display region, the light control element being arranged periodically in the first direction for giving a parallax in the first direction; wherein
each of the red color pixel, the green color pixel, and the blue color pixel includes a first sub-pixel and a second sub-pixel arranged in the second direction and having respective apertures,
a ratio of the sighted areas in the first sub-pixel and a second sub-pixel respectively arranged in the second direction is constant in each color pixel, and
the shape of the aperture region is approximately that of a parallelogram, and respective four corner portions of the first and second sub-pixels of each color pixel are arranged on a line approximately parallel to the second direction.

18. The three-dimensional display device according to claim 17, wherein the light control element comprises lentcuilar sheet.

19. The three-dimensional display device according to claim 17, wherein the light control element comprises slits.

20. The three-dimensional display device according to claim 17, wherein the forms of the aperture regions of the first and second sub-pixels of each color pixel are substantially the same.
